(19) United States
(12) Patent Application Publication
(10) Pub. No.: US 2012/0285400 A1
(43) Pub. Date: Nov. 15, 2012

(54) FUEL-PROPERTY REFORMING APPARATUS FOR INTERNAL COMBUSTION ENGINE

(75) Inventors: Hiroyuki Inuzuka, Obu-city (JP); Makoto Miwa, Kariya-city (JP)

(73) Assignee: DENSO CORPORATION, Kariya-city (JP)

(21) Appl. No.: 13/454,344

(22) Filed: Apr. 24, 2012

(30) Foreign Application Priority Data
May 11, 2011 (JP) 2011-105785

(51) Int. Cl. F02B 43/00

(52) U.S. Cl. 123/3

(57) ABSTRACT

An ECU computes a quantity of reforming-fuel which the reforming-fuel injector injects based on an engine driving condition and an EGR quantity. The injecting quantity of the reforming-fuel is properly adjusted according to an EGR gas temperature or an alcohol concentration of the reforming-fuel, whereby it can be restricted that temperature of a fuel-reforming catalyst and the EGR gas temperature are decreased due to a vaporization heat of the reforming-fuel. Also, an injecting time period of the reforming-fuel is properly adjusted, so that a maldistribution of the reforming-fuel is restricted. Furthermore, an injection cycle of the reforming-fuel is varies according to an engine speed, so that a supplied quantity of the reforming-fuel is made uniform for each cylinder.

### CROSS-REFERENCE TO RELATED APPLICATION

This application is based on Japanese Patent Application No. 2011-105785 filed on May 11, 2011, the disclosure of which is incorporated herein by reference.

### TECHNICAL FIELD

The present disclosure relates to a fuel-property reforming apparatus for an internal combustion engine, which reforms a property of fuel supplied to the internal combustion engine. The property of fuel is referred to as fuel property, hereinafter.

### BACKGROUND

US-2005-0045118A1 shows a method and a system for reforming fuel property. In this system, a bypass passage is fluidly connected to an intake passage of an internal combustion engine. A fuel injector injecting reforming-fuel for reforming the fuel property and a catalyst for reforming the fuel property are disposed in the bypass passage.

Also, JP-2006-291901A shows a fuel-property system in which a fuel injector injecting reforming-fuel and a catalyst for reforming the fuel property in an exhaust gas recirculation (EGR) passage.

If a lot of reforming-fuel is injected while temperature of a reforming-catalyst and temperature of EGR gas (medium fluid) flowing through the reforming-catalyst is low, the temperature of the reforming-catalyst and the EGR gas is further decreased due to vaporization heat of the reforming-fuel, which may deteriorate reforming-efficiency of the fuel.

Also, if a lot of reforming-fuel is injected and its injection cycle is relatively long, a concentration of the reforming-fuel flowing through the reforming-catalyst fluctuates, which may deteriorate reforming-efficiency of the fuel.

### SUMMARY

It is an object of the present disclosure to provide a fuel-property reforming apparatus for an internal combustion engine, which is able to improve reforming-efficiency of fuel.

According to the present disclosure, a fuel-property reforming apparatus includes: a reforming-fuel injector injecting a reforming-fuel into a medium fluid which will be supplied to an intake pipe of the internal combustion engine; a fuel reforming portion reforming the fuel in the medium fluid; and a reforming controller establishing an injection quantity of the reforming-fuel according to a driving condition of the internal combustion engine.

The reforming controller varies the injection quantity of the reforming-fuel according to a subject temperature which represents at least one of a temperature of the fuel reforming portion and a temperature of the medium fluid.

The injection cycle of the reforming-fuel is properly adjusted according to the subject temperature, so that the injecting quantity of the reforming-fuel can be properly adjusted according to the subject temperature. Thus, it can be restricted that the temperature of the fuel-reforming portion and the temperature of the medium fluid are decreased due to a vaporization heat of the reforming-fuel.

According to another disclosure, a fuel-property reforming apparatus includes: a reforming-fuel injector injecting a reforming-fuel into a medium fluid which will be supplied to an intake pipe of the internal combustion engine; a fuel reforming portion reforming the fuel in the medium fluid; and a reforming controller establishing an injection quantity of the reforming-fuel according to a driving condition of the internal combustion engine.

The reforming controller varies an injection cycle of the reforming-fuel according to a subject quantity which represents at least one of an injection quantity of the reforming-fuel and a flow rate of the medium fluid.

The injection cycle of the reforming-fuel can be properly adjusted, so that a maldistribution of the reforming-fuel is restricted. Thus, the fuel reforming portion is effectively utilized to improve the fuel reforming efficiency.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view of an engine control system according to an embodiment of the present invention;

FIGS. 2 and 3 are flow charts showing a processing of a reforming-fuel injection control;

FIG. 4 is a chart conceptually showing a map of a temperature correction coefficient;

FIG. 5 is a chart conceptually showing a map of an alcohol concentration correction coefficient;

FIG. 6 is a chart showing a map of an injection cycle of the reforming-fuel;

FIG. 7 is a chart for explaining a method for establishing the injection cycle of the reforming-fuel; and

FIG. 8 is a time chart for explaining an advantage of the reforming-fuel injection control according to the embodiment.

### DETAILED DESCRIPTION

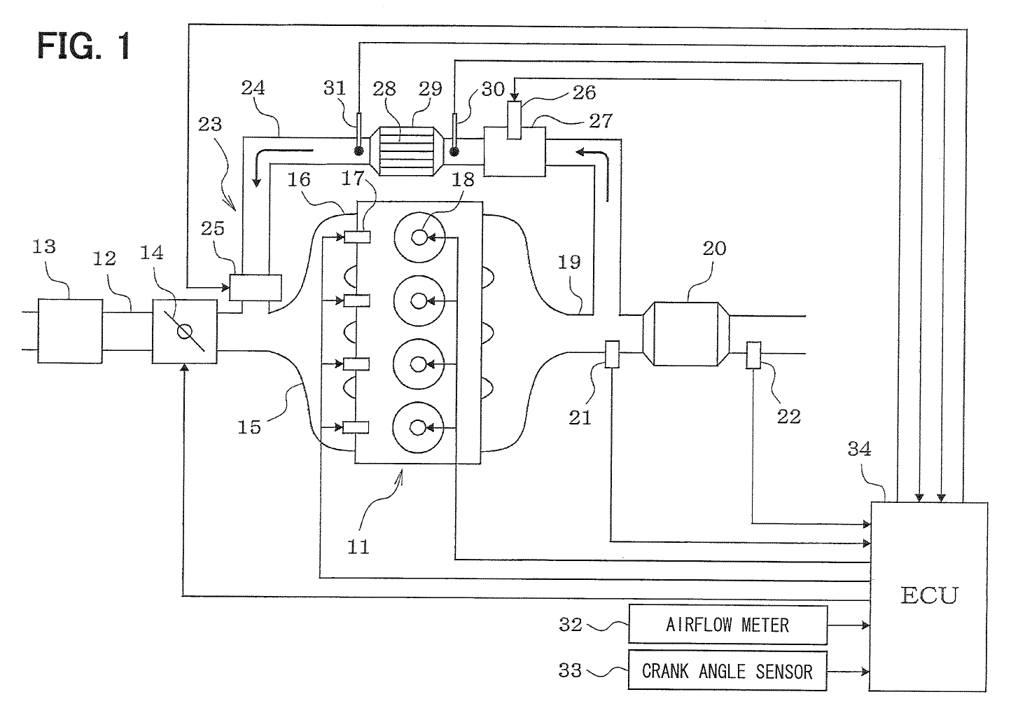

An embodiment of the present invention will be described hereinafter. First, referring to FIG. 1, an engine control system is explained.

An air cleaner 13 is arranged upstream of an intake pipe 12 of an internal combustion engine 11. A throttle valve 14 is arranged downstream of the air cleaner 13. An opening degree of the throttle valve 14 is adjusted by a motor (not shown).

A surge tank 15 is provided downstream of the throttle valve 14. An intake manifold 16 introducing air into each cylinder of the engine 11 is provided downstream of the surge tank 15, and the fuel injector 17 injecting the fuel is provided at a vicinity of an intake port (not shown) connected to the intake manifold 20 of each cylinder. A spark plug 18 is mounted on a cylinder head of the engine 11 corresponding to each cylinder to ignite air-fuel mixture in each cylinder.

An exhaust pipe 19 of the engine 11 is provided with a three-way catalyst 20 purifying CO, HC, NOx in the exhaust gas. Exhaust gas sensors 21 and 22, such as an air-fuel ratio sensor and an oxygen sensor, are disposed upstream and downstream of the three-way catalyst 20 to detect air-fuel ratio and rich/lean of the exhaust gas.

The engine 11 is provided with an exhaust gas recirculation (EGR) apparatus 23 for recirculating a part of exhaust gas (medium fluid) into the intake pipe 12. The EGR apparatus 23 has an EGR pipe 24 connecting the exhaust pipe 19 upstream of the catalyst 20 and the intake pipe 12 downstream of the throttle valve 14. An EGR valve 25 is provided in the EGR pipe 24 to adjust an exhaust gas recirculation quantity (external EGR quantity).

The EGR pipe 24 has a fuel injection apparatus 27 which is provided with a fuel injector 26 injecting reforming-fuel into the EGR gas. This fuel injector 26 injecting the reforming-fuel is referred to as a reforming-fuel injector 26, hereinafter. Further, the EGR pipe 24 has a fuel-reforming device 29 which is provided with a fuel-reforming catalyst 28 reforming the fuel property. Temperature sensors 30, 31 are provided at an inlet and an outlet of the fuel-reforming device 29. The fuel injector 17 and the reforming-fuel injector 26 receive the fuel from a common fuel tank (not shown).

An airflow meter 32 detecting intake air flow rate and a crank angle sensor 33 are disposed at outer circumference of a crank shaft (not shown) to output a pulse signal every when the crank shaft rotates a specified crank angle. Based on the output signal of the crank angle sensor 33, a crank angle and an engine speed are detected.

The outputs of the above sensors are transmitted to an electronic control unit (ECU) 34. The ECU 34 includes a microcomputer which executes an engine control program stored in a Read Only Memory (ROM) to control a fuel injection quantity, an ignition timing, a throttle position (intake air flow rate) and the like.

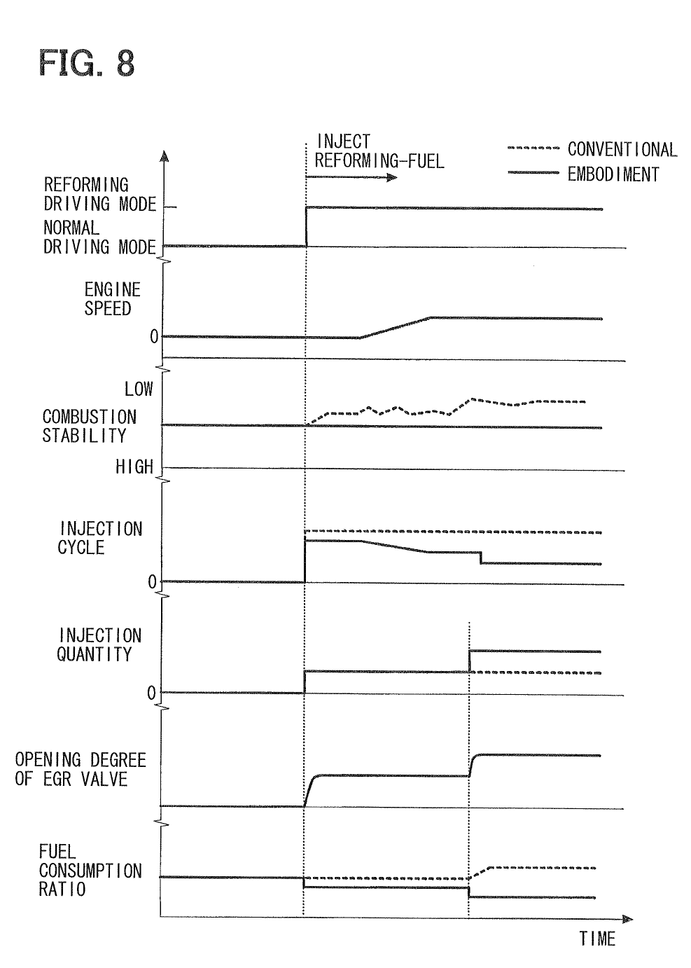

When the driving condition of the engine 11 is a specified reforming-condition, for example, when the engine speed is low and the engine load is low, the ECU 34 switches an engine driving mode from a normal driving mode to a reforming driving mode (refer to FIG. 8). In the reforming driving mode, while the EGR valve 25 is opened to recirculate a part of the exhaust gas into an intake pipe, the reforming-fuel injector 26 injects the reforming-fuel into the exhaust gas flowing through the EGR pipe 24. The injected reforming-fuel is vaporized and flows into the fuel-reforming catalyst 28. The fuel-reforming catalyst 28 reforms the fuel in the exhaust gas into the fuel having high combustibility. The reformed fuel is supplied to the intake pipe 12.

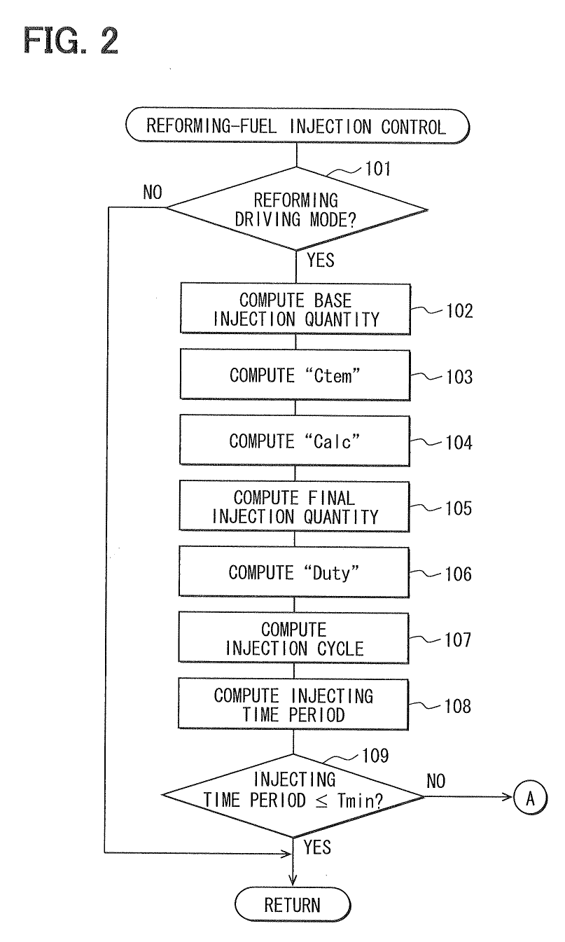

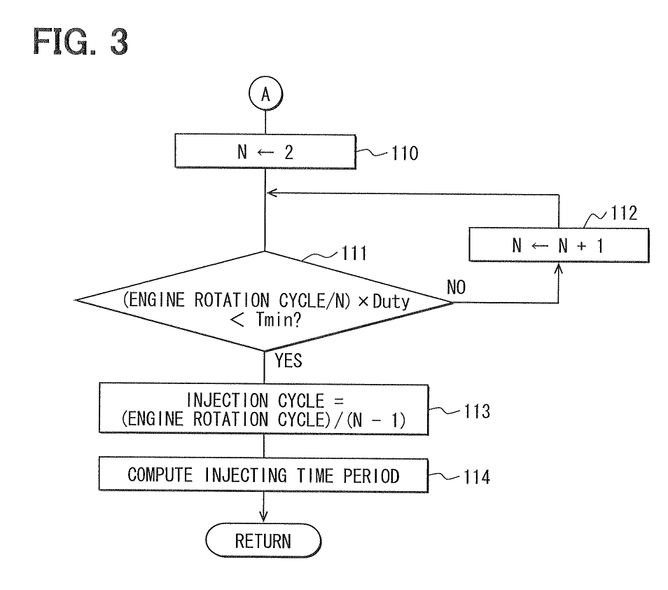

The ECU 34 executes a reforming-fuel injection control shown in FIGS. 2 and 3, whereby a quantity of the reforming-fuel which the reforming-fuel injector 26 injects is computed based on the engine driving condition and the EGR quantity by using of a map.

If a lot of reforming-fuel is injected while temperature of the fuel-reforming catalyst 28 and temperature of EGR gas flowing through the fuel-reforming catalyst 28 is low, the temperature of the fuel-reforming catalyst 28 and the EGR gas is further decreased due to vaporization heat of the reforming-fuel, which may deteriorate reforming-efficiency of the fuel.

According to the present embodiment, the injection quantity of the reforming-fuel is adjusted based on the temperature of EGR gas (EGR gas temperature). The injecting quantity of the reforming-fuel is properly adjusted according to the EGR gas temperature, whereby it can be restricted that the temperature of the fuel-reforming catalyst 28 and the EGR gas is decreased due to the vaporization heat of the reforming-fuel.

In an engine control system where gasoline, alcohol, or a mixture of gasoline and alcohol can be used as the fuel, if alcohol concentration of the reforming-fuel is higher, the vaporization heat quantity of the reforming-fuel becomes greater, which may increase the temperature drop of the EGR gas and the fuel-reforming catalyst 28 due to the vaporization heat of the reforming-fuel.

According to the present embodiment, the injection quantity of the reforming-fuel is adjusted according to the alcohol concentration of the reforming-fuel. The injecting quantity of the reforming-fuel is properly adjusted according to the alcohol concentration of the reforming-fuel, whereby it can be restricted that the temperature of the fuel-reforming catalyst 28 and the EGR gas is decreased due to the vaporization heat of the reforming-fuel.

Also, if a lot of reforming-fuel is injected and its injection cycle is relatively long, a concentration of the reforming-fuel flowing through the fuel-reforming catalyst 28 fluctuates, which may deteriorate reforming-efficiency of the fuel.

According to the present embodiment, the injection cycle of the reforming-fuel is adjusted according to the injection quantity of the reforming-fuel and the EGR gas quantity. The injection cycle of the reforming-fuel is properly adjusted, whereby it can be restricted that the concentration of the reforming-fuel flowing through the fuel-reforming catalyst 28 fluctuates.

Referring to FIGS. 2 and 3, a reforming-fuel injection control routine will be described.

This routine is executed at a specified cycle while the ECU 34 is ON. In step 101, the computer determines whether it is in the reforming driving mode. When the answer is NO, the procedure ends.

When the answer is YES in step 101, the procedure proceeds to step 102. In step 102, the computer computes a base injection quantity of the reforming-fuel is computed based on the engine driving condition and the EGR quantity by using of a map. The map of the base injection quantity of the reforming-fuel is previously formed based on experimental data and design data, and is stored in the ROM of the ECU 34.

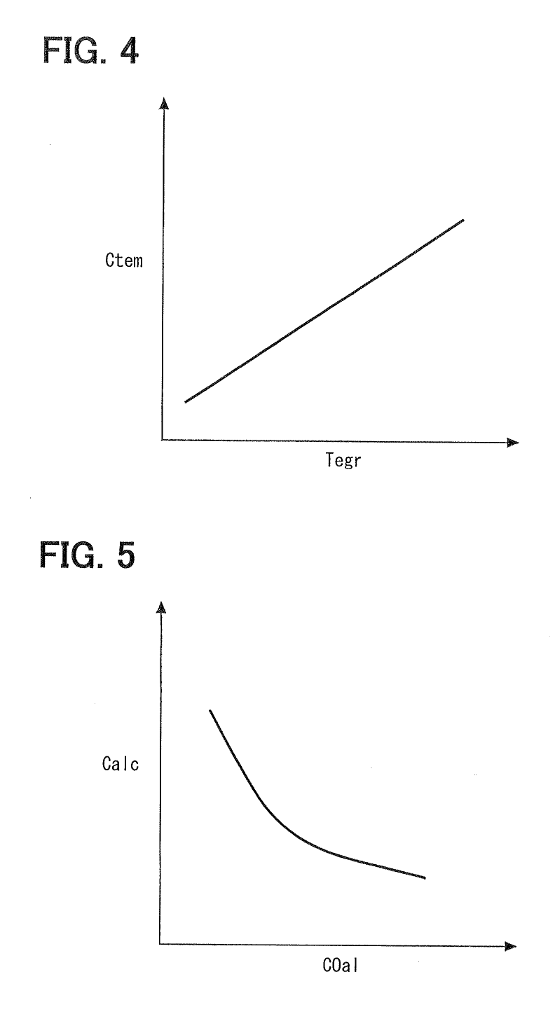

Then, the procedure proceeds to step 103 in which a temperature correction coefficient (Ctem) depending on the EGR gas temperature (Tegr) is computed in view of a map of temperature correction coefficient shown in FIG. 4. This map is previously formed based on experimental data and design data, and is stored in the ROM of the ECU 34. The EGR gas temperature “Tegr” is detected based on the detection values of the temperature sensors 30 and 31. An average value of the detection values of the sensors 30 and 31 may be defined as the “Tegr”.

In the map shown in FIG. 4, as the “Tegr” becomes larger, the “Ctem” becomes larger. Thus, when the “Tegr” is relatively low, the injection quantity of the reforming-fuel is decreased, whereby it can be restricted that the temperature of the fuel-reforming catalyst 28 and the EGR gas is decreased due to the vaporization heat of the reforming-fuel. When the “Tegr” is relatively high, the injection quantity of the reforming-fuel is increased.

Then, the procedure proceeds to step 104 in which an alcohol concentration correction coefficient “Calc” depending on the alcohol concentration “COal” of the reforming-fuel is computed with reference to a map of the alcohol concentration correction coefficient which is shown in FIG. 5. This map of the correction coefficient is previously formed based on experimental data and design data, and is stored in the ROM of the ECU 34. The alcohol concentration can be detected by an alcohol concentration sensor (not shown), or estimated based on the air-fuel ratio correction amount, the engine speed, the combustion pressure and the like.

In the map shown in FIG. 5, as the “COal” becomes larger, the “Calc” becomes smaller. Thus, when the “COal” becomes larger, the injection quantity of the reforming-fuel is decreased to avoid the temperature drop of the EGR gas and the fuel-reforming catalyst 28.

Then, the procedure proceeds to step 105 in which the base injection quantity of the reforming-fuel is corrected by using of the “Ctem” and ““Calc” to obtain a final injection quantity. In step 106, the computer computes an injection duty “Duty” of the reforming-fuel injection injector 26 based on the above final injection quantity.

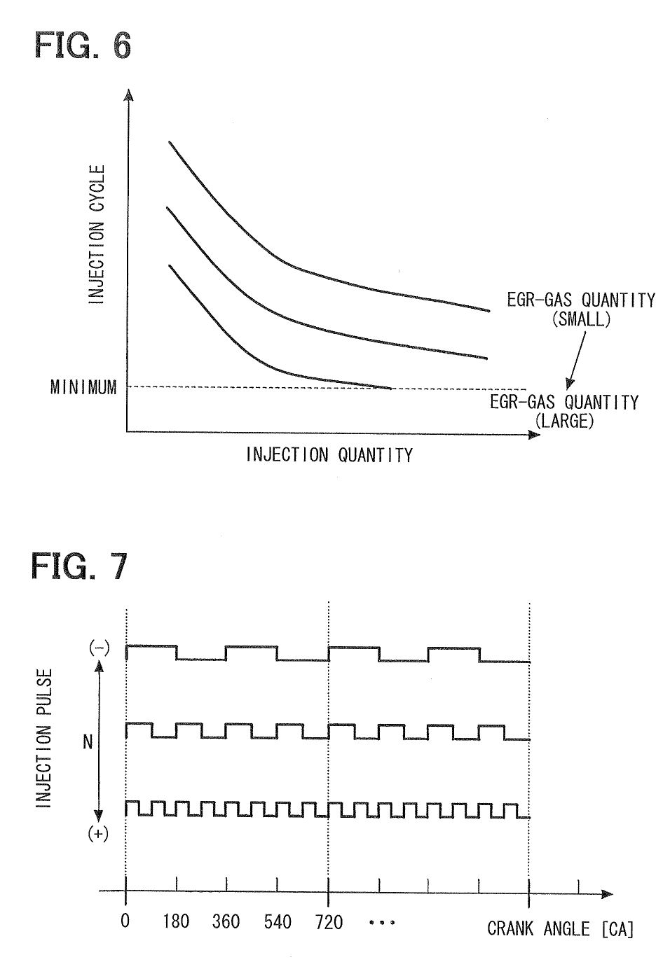

Then, the procedure proceeds to step 107 in which an injection cycle of the reforming-fuel is computed in view of a map of injection cycle shown in FIG. 6. This map is previously formed based on experimental data and design data, and is stored in the ROM of the ECU 34. It should be noted that the injection cycle is a time period from when the reforming-fuel injector 26 injects the reforming-fuel until when the reforming-fuel injector 26 injects the reforming fuel successively again.

In the map shown in FIG. 6, as the injection quantity of the reforming-fuel becomes greater, the injection cycle becomes shorter. By making the injection cycle shorter, a maldistribution of the reforming-fuel is restricted. Also, in the map shown in FIG. 6, as the EGR gas quantity becomes greater, the injection cycle becomes shorter. By making the injection cycle shorter, a maldistribution of the reforming-fuel is restricted.

Furthermore, a minimum injection cycle is greater than a minimum fuel injecting time period “Tmin” of the reforming-fuel injector 26. The injection cycle can be variably established.

Then, the procedure proceeds to step 108 in which an injecting time period of the reforming-fuel is computed base on the injection cycle and the injection duty “Duty” (Injecting time period=injection cycle×Duty). In step 109, the computer determines whether the injecting time period of the reforming-fuel is less than a minimum fuel injecting time period “Tmin” of the reforming-fuel injector 26.

When the answer is YES in step 109, the injection cycle and injecting time period established in steps 107 and 108 are employed.

When the answer is NO in step 109, the procedure proceeds to step 110 shown in FIG. 3. In step 110, the number of partitions N is set to an initial value “2”. In step 111, the computer determines whether (engine rotation cycle/N)×“Duty” is shorter than the minimum fuel injecting time period “Tmin”.

(Engine rotation cycle/N)×Duty<“Tmin”. (1)

The engine rotation cycle is a time period required for a crankshaft to perform one rotation, which varies based on the engine speed.

When the answer is NO in step 111, the procedure proceeds to step 112 in which the number of partition “N” is incremented by “1”, and then the procedure goes back to step 111.

When the answer is YES in step 111, the procedure proceeds to step 113 in which (Engine rotation cycle/(N−1)) is defined as the fuel injection cycle of the reforming-fuel.

Injection cycle of reforming-fuel=engine rotation cycle/(N−1) (2)

Then, the procedure proceeds to step 114 in which the injecting time period of the reforming-fuel is computed based on the injection cycle of reforming-fuel and the injection duty “Duty”.

By executing steps 110 to 114, the injection cycle of the reforming-fuel is changed according to the engine rotation cycle and the injection cycle of the reforming-fuel is established minimum in a range where the injecting time period of the reforming-fuel injector 26 is greater than the minimum injecting time period “Tmin” (refer to FIG. 7).

According to the present embodiment described above, since the injection quantity of the reforming-fuel is adjusted based on the EGR gas temperature, the injecting quantity of the reforming-fuel can be properly adjusted according to the EGR gas temperature, whereby it can be restricted that the temperature of the fuel-reforming catalyst 28 and the EGR gas is decreased due to the vaporization heat of the reforming-fuel. Thus, the reforming efficiency of the fuel can be enhanced.

Further, according to the present embodiment, the fuel injection cycle is adjusted according to the injection quantity of the reforming-fuel and the EGR gas quantity, whereby the fuel injection cycle of the reforming-fuel can be appropriately established and a maldistribution of the reforming-fuel is restricted. Thus, the fuel-reforming catalyst 28 is effectively utilized to improve the fuel reforming efficiency.

According to the present embodiment, the injection cycle of the reforming-fuel is changed according to the engine rotation cycle and the injection cycle of the reforming-fuel is established minimum in a range where the injecting time period of the reforming-fuel injector 26 is greater than the minimum injecting time period “Tmin”. Thus, it can be avoided that the supplied reforming-fuel quantity disperses among cylinders. The reforming-fuel quantity supplied to each cylinder can be made substantially uniform.

Also, according to the present embodiment, since the injection quantity of the reforming-fuel is adjusted according to the alcohol concentration of the reforming-fuel, the injecting quantity of the reforming-fuel can be properly adjusted according to the alcohol concentration. Thus, it can be restricted that the temperature of the fuel-reforming catalyst 28 and the EGR gas is decreased due to the vaporization heat of the reforming-fuel.

In FIG. 8, dashed lines represent a conventional fuel injection control in which the reforming-fuel quantity and reforming-fuel injection cycle are not adjusted during the reforming driving mode. Comparing with the conventional control, a combustion stability and fuel consumption ratio can be improved in the present embodiment.

In the above embodiment, the injection quantity of the reforming-fuel is adjusted based on the EGR gas temperature. Alternatively, the injection quantity of the reforming-fuel can be adjusted based on the temperature of the fuel-reforming catalyst 28, or both of the catalyst temperature and the EGR gas temperature.

The reforming-fuel injection cycle may be varied according to only one of the reforming-fuel injection quantity and the EGR gas quantity.

The reforming-fuel injection cycle may be set shorter as the alcohol concentration of the reforming-fuel becomes higher. This can restricts a maldistribution of the reforming-fuel.

The EGR pipe may be provided with only the reforming-fuel injector. The fuel-reforming catalyst is not always necessary.

The reforming-fuel injector and the fuel-reforming catalyst may be arranged downstream of a supercharger in the intake pipe. Alternatively, only the reforming-fuel injector may be arranged downstream of the supercharger in the intake pipe. In this case, the reforming-fuel is injected into high-pressure intake air boosted by the supercharger to reform the fuel. The supercharger functions as the fuel reforming apparatus.

The present invention is not limited to an intake port injection engine. The present invention can be applied to a direct injection engine or a dual injection engine.

What is claimed is:

1. A fuel-property reforming apparatus for an internal combustion engine, comprising:
a reforming-fuel injector injecting a reforming-fuel into a medium fluid which will be supplied to an intake pipe of the internal combustion engine;
a fuel reforming portion reforming the fuel in the medium fluid; and
a reforming controller establishing an injection quantity of the reforming-fuel according to a driving condition of the internal combustion engine, wherein:
the reforming controller varies the injection quantity of the reforming-fuel according to a subject temperature which represents at least one of a temperature of the fuel reforming portion and a temperature of the medium fluid.

2. A fuel-property reforming apparatus according to claim 1, wherein
the reforming controller decreases the injection quantity of the reforming-fuel as the subject temperature becomes lower; and
the reforming controller increases the injection quantity of the reforming-fuel as the subject temperature becomes higher.

3. A fuel-property reforming apparatus for an internal combustion engine, comprising:
a reforming-fuel injector injecting a reforming-fuel into a medium fluid which will be supplied to an intake pipe of the internal combustion engine;
a fuel reforming portion reforming the fuel in the medium fluid; and
a reforming controller establishing an injection quantity of the reforming-fuel according to a driving condition of the internal combustion engine, wherein:
the reforming controller varies an injection cycle of the reforming-fuel according to a subject quantity which represents at least one of an injection quantity of the reforming-fuel and a flow rate of the medium fluid.

4. A fuel-property reforming apparatus according to claim 1, wherein
a minimum value of the injection cycle of the reforming-fuel is established greater than or equal to a minimum injection time period of the reforming-fuel injector.

5. A fuel-property reforming apparatus according to claim 3, wherein
the reforming controller makes the injection cycle of the reforming-fuel shorter as the injection quantity of the reforming-fuel becomes greater.

6. A fuel-property reforming apparatus according to claim 3, wherein
the reforming controller makes the injection cycle of the reforming-fuel shorter as the flow rate of the medium fluid becomes greater.

7. A fuel-property reforming apparatus according to claim 3, wherein
the reforming controller varies the injection cycle of the reforming-fuel according to an rotation speed of the internal combustion engine.

8. A fuel-property reforming apparatus according to claim 1, wherein
the reforming controller varies the injection quantity of the reforming-fuel according to an alcohol concentration of the reforming-fuel.

9. A fuel-property reforming apparatus according to claim 8, wherein
the reforming controller decreases the injection quantity of the reforming-fuel as the alcohol concentration becomes higher.

10. A fuel-property reforming apparatus according to claim 9, wherein
the reforming controller makes the injection cycle of the reforming-fuel shorter as the alcohol concentration becomes higher.
